(19) United States
(12) Patent Application Publication
(10) Pub. No.: US 2023/0168377 A1
(43) Pub. Date: Jun. 1, 2023

(54) SURVEY SYSTEM AND METHOD FOR CONTROLLING THE SURVEY SYSTEM

(71) Applicant: TOPCON CORPORATION, Tokyo (JP)

(72) Inventors: Takeshi KIKUCHI, Tokyo (JP); Yuji TAKANO, Tokyo (JP)

(21) Appl. No.: 18/070,258

(22) Filed: Nov. 28, 2022

(30) Foreign Application Priority Data
Nov. 30, 2021 (JP) 2021-195011

(51) Int. Cl. G01S 17/42; G01S 7/481; G01S 17/86; G06T 7/70

(52) U.S. Cl. CPC G01S 17/42; G01S 7/4817; G01S 17/86; G06T 7/70; G06T 2207/10012; G06T 2207/20081

(57) ABSTRACT

A survey system includes: a target unit; a surveying instrument configured to transmit distance-measuring light to the target and receive reflected distance-measuring light to measure a distance and an angle to the target; an eyewear display device including a display; and a processor configured to synchronize information on positions and directions of the eyewear display device, the surveying instrument, and data in an absolute coordinate system. The processor causes the display to display a measurement point superimposing on a landscape of a survey site, to irradiate a target position set at the measurement point, calculated from three-dimensional position coordinates of the measurement point and a target height, with a guide distance-measuring light, and, in a state where an irradiation direction of the guide distance-measuring light and a center of the target actually set at the measurement point are matched, the surveying instrument is caused to measure the center of the target.

### CROSS-REFERENCE TO RELATED APPLICATION, BENEFIT CLAIM, AND INCORPORATION BY REFERENCE

The present application claims priority under 35 U.S.C. §119 to Japanese Patent Application No. 2021-195011 filed Nov. 30, 2021. The contents of this application are incorporated herein by reference in their entirely.

### TECHNICAL FIELD

The present invention relates to a survey system and a method for controlling the survey system, more specifically, to a survey system using an eyewear display device and a method for controlling the survey system.

### BACKGROUND ART

Conventionally, a survey system that enables a one-man survey by automatically tracking a target held by a worker by using a surveying instrument having an automatic tracking function has been known (for example, refer to Patent Literature 1).

### CITATION LIST

### Patent Literature

Patent Literature 1: Japanese Published Unexamined Patent Application No. 2017-58556

### SUMMARY OF INVENTION

### Technical Problem

However, even with a survey system that tracks a target by an automatic tracking function, in a case of measurement of a first point or a case where automatic tracking fails, complicated work is required in which a surveying instrument is directed toward a prism by detecting guide light with a guide light detecting unit equipped in the surveying instrument, by using a remote controller that includes a target and performs scanning with fan-shaped guide light in the vertical direction.

Meanwhile, in recent years, a survey assistance system using an eyewear display device which can communicate with the surveying instrument and enables information on a position and a direction acquired by a surveying instrument to be managed in a coordinate space with a common origin has been proposed.

The present invention was made in view of these circumstances, and an object thereof is to provide a technology that enables a surveying instrument of sighting a prism without complicated work.

### Solution to Problem

In order to achieve the object described above, a survey system according to an aspect of the present invention includes a target unit including a target and a support member configured to support the target, a surveying instrument including a telescope and configured to drive and rotate the telescope in a vertical direction and a horizontal direction to transmit distance-measuring light along a collimation optical axis of the telescope to the target and receive reflected distance-measuring light from the target to measure a distance to the target, and configured to detect a collimation direction of the telescope so as to measure an angle of the target, so as to acquire three-dimensional position coordinates of the target, an eyewear display device including a display, a relative position sensor configured to detect a position, and a relative direction sensor configured to detect a direction, and a processor configured to match a coordinate space of information on a position and a direction acquired by the eyewear display device, a coordinate space of the surveying instrument, and a coordinate space of an absolute coordinate system, to enable information on a position and direction of the eyewear display device, the surveying instrument and data created in the absolute coordinate system to be managed in a common space with an origin set at a common reference point. The processor is configured to cause the eyewear display device to display a measurement point set as coordinates in the absolute coordinate system on the display by superimposing the measurement point on a landscape of a survey site, and cause the surveying instrument to irradiate a target position set at the measurement point, calculated in consideration of three-dimensional position coordinates of the measurement point and a target height, with the distance-measuring light as guide distance-measuring light. In a state where an irradiation direction of the guide distance-measuring light and a center of the target actually set at the measurement point are matched, the surveying instrument is caused to measure the center of the target.

A method for controlling a survey system according to another aspect of the present invention is a method for controlling a survey system including a target unit including a target and a support member configured to support the target,

a surveying instrument including a telescope and configured to drive and rotate the telescope in a vertical direction and a horizontal direction, and transmit distance-measuring light along a collimation optical axis of the telescope to the target a distance-measuring light and receive reflected distance-measuring light from the target, to measure a distance to the target, and configured to detect a collimation direction of the telescope to measure an angle of the target, so as to acquire three-dimensional position coordinates of the target, an eyewear display device including a display, a relative position sensor configured to detect a position, and a relative direction sensor configured to detect a direction, and a processor configured to match a coordinate space of information on a position and a direction acquired by the eyewear display device, a coordinate space of the surveying instrument, and a coordinate space of an absolute coordinate system, to enable information on a position and direction of the eyewear display device, the surveying instrument and data created in the absolute coordinate system to be managed in a common space with an origin set at a common reference point, the method includes: causing the eyewear display device to display a measurement point set as coordinates in the absolute coordinate system on the display by superimposing the measurement point on a landscape of a survey site; causing the surveying instrument to irradiate a target position set at the measurement point, calculated in consideration of three-dimensional position coordinates of the measurement point and a target height, with the distance-measuring light as guide distance-measuring light; and in a state where an irradiation direction of the guide distance-measuring light and a center of the target actually set at the measurement point are matched, causing the surveying instrument to measure the center of the target. Benefits of Invention

According to the survey system and the method for controlling the survey system according to the configuration described above, the surveying instrument can sight the target without complicated work.

### BRIEF DESCRIPTION OF DRAWINGS

FIG. 1 is a view illustrating an outline of a survey system according to a first embodiment.

FIG. 2 is an entire configuration block diagram of the same system.

FIG. 3 is a configuration block diagram of a surveying instrument included in the same system.

FIG. 4 is an external perspective view of an eyewear display device included in the same system.

FIG. 5 is a configuration block diagram of the same eyewear display device and a data processing device.

FIG. 6 is a flowchart of initial settings of the same system.

FIG. 7 is a view describing an outline of the above initial setting work.

FIG. 8 is a flowchart of a survey method using the same system.

FIGS. 9A, 9B, 9C, and 9D are views illustrating display examples of the eyewear display device in the same survey method.

FIG. 10 is a configuration block diagram of an eyewear display device and a data processing device constituting a survey system according to a second embodiment.

FIG. 11 is an external perspective view of the same eyewear device.

FIG. 12 is a flowchart of a survey method using the same system.

FIGS. 13A, 13B, 13C, and 13D are views describing a method for correcting guide distance-measuring light in the same system.

FIGS. 14A and 14B are diagrams describing deviations of an irradiation direction of the guide distance-measuring light in the same system.

FIG. 15 is a view describing a deviation of an irradiation direction of the guide distance-measuring light.

FIG. 16 is a configuration block diagram of an eyewear display device and a data processing device included in a survey system according to a third embodiment.

FIG. 17 is a diagram illustrating an example of teacher data for generation of a learning model for estimating a deviation of the guide distance-measuring light of the system.

FIG. 18 is a diagram describing an outline of generation of a deviation estimation model using the data.

FIG. 19 is a flowchart of a survey method using the same system.

FIG. 20 is a view describing a deviation of an irradiation direction of guide distance-measuring light in a modification of the survey system according to the third embodiment.

FIG. 21 is a diagram illustrating an example of teacher data for generation of a learning model for estimating a deviation of the guide distance-measuring light in the modification.

FIG. 22 is a diagram describing an outline of generation of a deviation estimation model using the data.

FIG. 23 is a configuration block diagram of an eyewear display device and a data processing device constituting a survey system according to a fourth embodiment.

FIG. 24 is an external schematic view of a target unit constituting the same system.

FIG. 25 is a view describing an example of calculation of an optimum target height in the same system.

FIG. 26 is a flowchart of a survey method using the same system.

### DESCRIPTION OF EMBODIMENTS

Hereinafter, preferred embodiments of the present invention will be described with reference to the drawings, however, the present invention is not limited to these. In the respective embodiments, components corresponding to each other are provided with the same name, and components having the same mechanical configuration are provided with the same reference signs, and overlapping descriptions will be omitted as appropriate.

### I. First Embodiment

### 1. Survey System 100

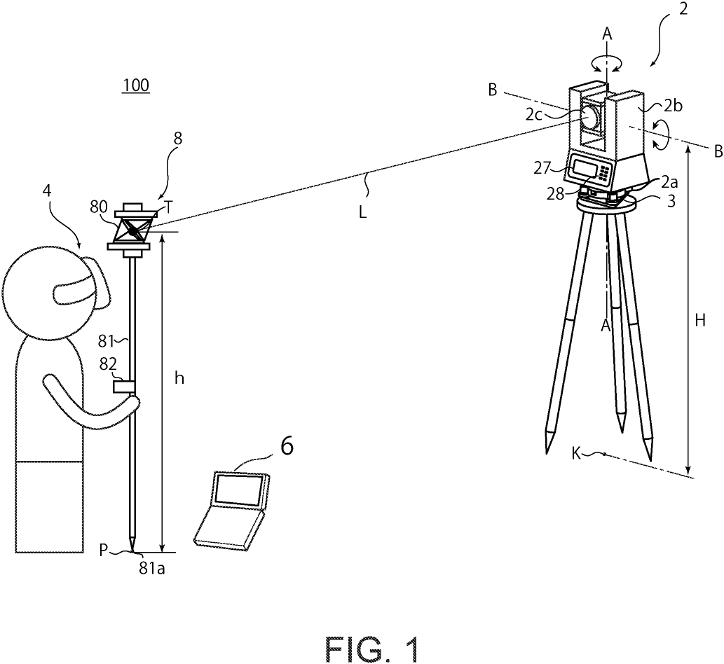

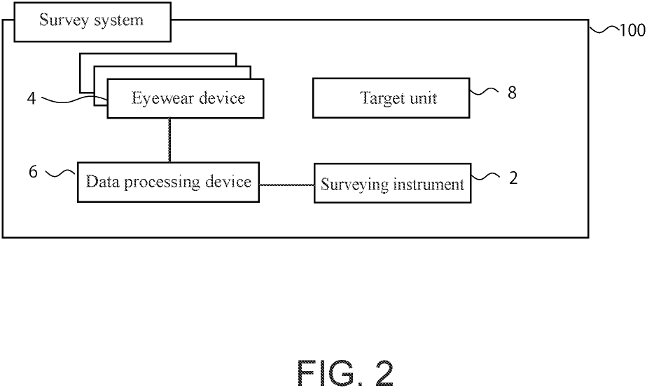

FIG. 1 is a view illustrating an outline of a survey system (hereinafter, also simply referred to as “system”) 100 according to a first embodiment of the present invention, and FIG. 2 is a configuration block diagram of the system 100. The system 100 includes a surveying instrument 2, an eyewear display device (hereinafter, referred to as “eyewear device”) 4, a data processing device 6, and a target unit 8.

### 2. Surveying Instrument 2

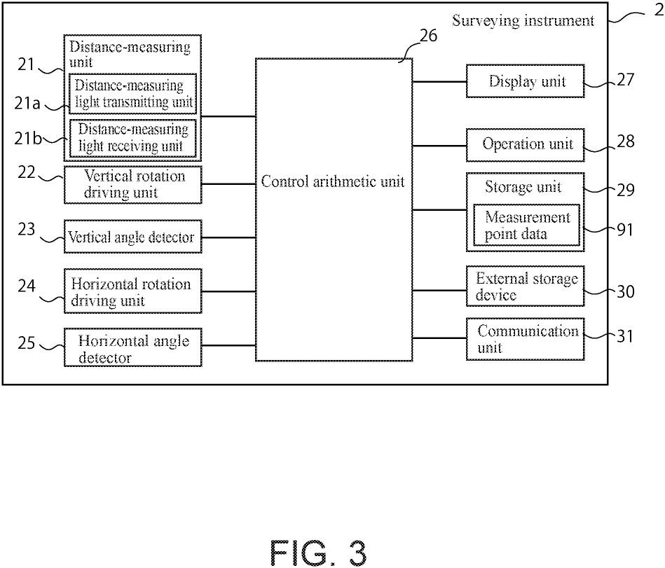

FIG. 3 is a configuration block diagram of the surveying instrument 2 included in the system 100. In the present embodiment, the surveying instrument 2 is a motor-driven total station. The surveying instrument 2 includes a distance-measuring unit 21, a vertical rotation driving unit 22, a vertical angle detector 23, a horizontal rotation driving unit 24, a horizontal angle detector 25, a display unit 27, an operation unit 28, a storage unit 29, an external storage device 30, a communication unit 31, and a control arithmetic unit 26.

As illustrated in FIG. 1, the surveying instrument 2 is installed at a known point K by using a tripod. The surveying instrument 2 includes, in appearance, a base portion 2a provided on a leveling base 3, a bracket portion 2b that rotates horizontally on the base portion 2a, and a telescope 2c that rotates vertically at a center of the bracket portion 2b. In the figure, H represents a height of a collimation optical axis along which the telescope 2c is collimated, that is, a height of an instrument center, and is obtained by adding a known height from a bottom surface of the surveying instrument 2 inside the surveying instrument 2 to the instrument center to a so-called instrument height of the surveying instrument 2 from the ground surface.

The distance-measuring unit 21 includes at least a distance-measuring light transmitting unit 21a including a light emitting element that emits distance-measuring light as visible laser light, and a light transmitting optical system, and a distance-measuring light receiving unit 21b including a light receiving optical system that shares a part of optical elements with the light transmitting optical system, and a light receiving element, for example, an Avalanche Photodiode, etc. According to control of the control arithmetic unit 26, the distance-measuring unit 21 outputs distance-measuring light along the collimation optical axis toward a target 80, and receives reflected distance-measuring light from the target 80 by the light receiving element to detect a distance to the target 80 based on a received light signal. The distance-measuring light transmitting unit 21a outputs distance-measuring light as guide distance-measuring light L indicating a collimation direction of the surveying instrument 2 according to control of the control arithmetic unit 26. The guide distance-measuring light L is the same light beam as distance-measuring light output at the time of measurement, but is referred to as guide distance-measuring light L for distinction.

The vertical rotation driving unit 22 and the horizontal rotation driving unit 24 are motors, and are controlled by the control arithmetic unit 26. The horizontal rotation driving unit 24 rotates the bracket portion 2b in the horizontal direction about an axis A-A in FIG. 1, and the vertical rotation driving unit 22 rotates the telescope 2c in the vertical direction about an axis B-B in FIG. 1. The vertical rotation driving unit 22 and the horizontal rotation driving unit 24 correspond to the rotation driving unit in the claims.

The vertical angle detector 23 and the horizontal angle detector 25 are rotary encoders. The vertical angle detector 23 measures a rotation angle of the telescope 2c in the vertical direction, and the horizontal angle detector 25 measures a rotation angle of the bracket portion 2b in the horizontal direction. The vertical angle detector 23 and the horizontal angle detector 25 correspond to the angle-measuring unit in the claims.

The display unit 27 is, for example, a liquid crystal display. The operation unit 28 includes a power key, numeric keys, a decimal key, a plus/minus key, an execution key, a scroll key, etc. This makes the operation unit enable a worker to operate the surveying instrument 2 and input information into the surveying instrument 2.

The storage unit 29 is, for example, an HDD (Hard Disc Drive), and stores various data and programs for executing functions of the control arithmetic unit 26. Specifically, the storage unit 29 stores a survey execution program for performing a survey. In addition, the storage unit 29 stores measurement point data 91.

The measurement point data 91 is three-dimensional position coordinate data of a measurement point P planned for a survey work, and is data set as coordinates in an absolute coordinate system created from three-dimensional CAD (Computer Aided Design) design data of a survey site created in the same absolute coordinate system as a coordinate system of the known point. The measurement point data 91 may include a plurality of measurement points P and information on a measurement order, etc., of the measurement points.

The external storage device 30 is, for example, a memory card, etc., and stores survey result data and various data acquired by the surveying instrument 2.

The communication unit 31 is a communication control device such as a network adapter, a network interface card, a LAN card, or a Bluetooth (registered trademark) adapter, and connects the surveying instrument 2 to the eyewear device 4 and the data processing device 6 by wire or wirelessly. The control arithmetic unit 26 can transmit and receive information to and from the eyewear device 4 and the data processing device 6 through the communication unit 31.

The control arithmetic unit 26 is a control arithmetic unit including at least one processor (for example, CPU (Central Processing Unit)), and at least one memory (for example, SRAM (Static Random Access Memory), DRAM (Dynamic Random Access Memory), etc.). The processor reads out necessary data and programs from the storage unit 29 into the memory and executes processing for realizing the functions of the surveying instrument 2.

By controlling transmission of distance-measuring light of the distance-measuring unit 21, the control arithmetic unit 26 calculates a distance to the target 80 from a received light signal of the distance-measuring light receiving unit 21b. Specifically, for example, calculation is made based on a phase difference between reflected light from the target 80 and reference light splitting a part of distance-measuring light and traveling through a reference light path provided inside the telescope 2c. In addition, the control arithmetic unit 26 detects angles of the target 80 based on detection results of the vertical angle detector 23 and the horizontal angle detector 25. Accordingly, the control arithmetic unit 26 calculates three-dimensional position coordinates of the target 80.

By controlling the vertical rotation driving unit 22 and the horizontal rotation driving unit 24, the control arithmetic unit 26 directs a collimation optical axis of the telescope 2c of the surveying instrument 2 toward the center of the target 80 (hereinafter, referred to as “target position Tp”) in a case where the target unit 8 is installed at the measurement point P. In addition, by controlling the distance-measuring light transmitting unit 21a, the control arithmetic unit 26 applies and turns off distance-measuring light as guide distance-measuring light L toward the target 80. Irradiation control of the guide distance-measuring light L by the control arithmetic unit 26 is executed according to, for example, a remote operation by a target position irradiating unit 643 of the data processing device 6.

### 3. Eyewear Device 4

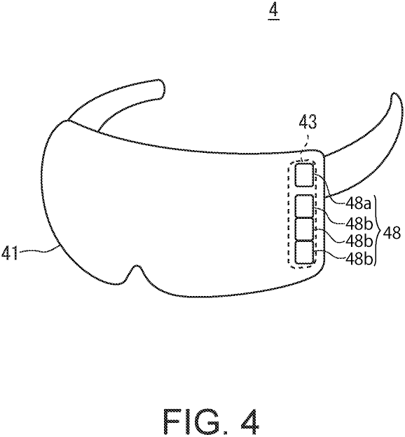

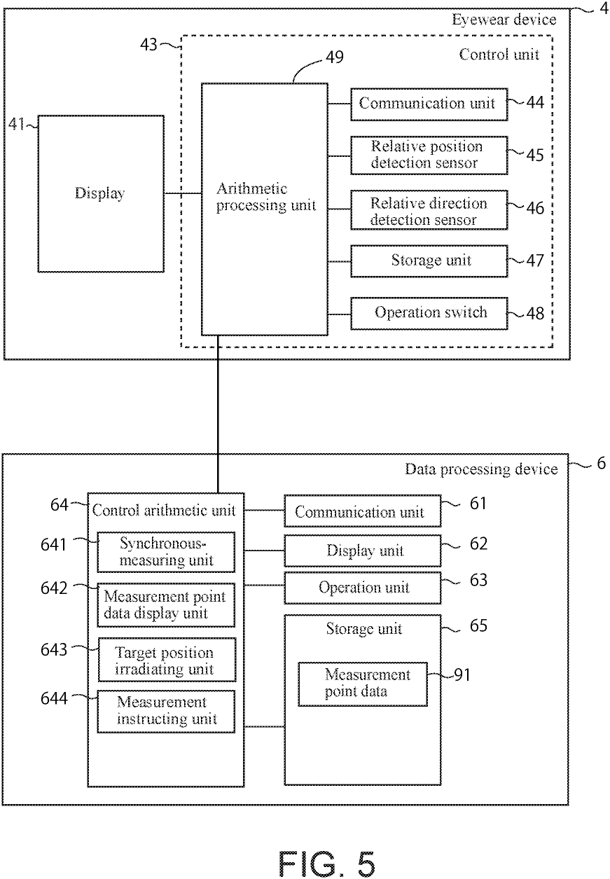

FIG. 4 is an external perspective view of the eyewear device 4, and FIG. 5 is a configuration block diagram of the eyewear device 4 and the data processing device 6. The eyewear device 4 is a wearable device to be worn on the head of a worker, and includes a display 41 and a control unit 43. The control unit 43 includes a communication unit 44, a relative position detection sensor (hereinafter, referred to as “relative position sensor”) 45, a relative direction detection sensor (hereinafter, referred to as “relative direction sensor”) 46, a storage unit 47, an operation switch 48, and an arithmetic processing unit 49.

The display 41 is a goggles-lens-shaped transmissive display that covers the eyes of a worker when the worker wears the eyewear device. As an example, the display 41 is an optical see-through display using a half mirror, and displays an image received by the control unit 43 from the data processing device 6 by superimposing the image on a site landscape. Alternatively, the display 41 may be a video see-through display, and display an image received by the control unit 43 by superimposing the image on a front landscape image acquired in real time by a camera (not illustrated). As a projection method, a virtual image projection method may be used, or a retina projection method may be used.

When the display 41 is a video see-through display, its camera includes an image sensor, for example, a CCD (Charge Coupled Device), CMOS (Complementary Metal Oxide Semiconductor), etc., and takes a front landscape image of the eyewear device 4 in real time. The image sensor has an orthogonal coordinate system with an origin set at a camera center, and local coordinates of each pixel are identified. A positional relationship between the camera center and a center of the eyewear device 4 is known, and the arithmetic processing unit 49 can convert a coordinate space of an image acquired by the camera into a coordinate space of the eyewear device 4 and manage the image.

The communication unit 44 is a communication control device such as a network adapter, a network interface card, a LAN card, or a Bluetooth adapter. The eyewear device 4 can transmit and receive information to and from the surveying instrument 2 and the data processing device 6 by communicating with these by wire or wirelessly through the communication unit 44.

The relative position sensor 45 detects a position of the eyewear device 4 in an observation site by performing radio determination from an antenna for a GNSS (Global Navigation Satellite System), a Wi-Fi (registered trademark) access point, and an ultrasonic oscillator, etc., installed at the observation site.

The relative direction sensor 46 consists of a combination of a triaxial accelerometer or gyro sensor and a tilt sensor. The relative direction sensor 46 detects a tilt of the eyewear device 4 by defining the up-down direction as a Z-axis direction, the left-right direction as a Y-axis direction, and the front-rear direction as an X-axis direction.

The storage unit 47 is, for example, a memory card. The storage unit 47 stores programs for the arithmetic processing unit 49 to execute functions.

The operation switch 48 is, for example, push buttons provided on an outer surface of the display 41. The operation switch 48 includes, for example, a power button 48a for turning ON/OFF a power supply of the eyewear device 4, and function buttons 48b that enable a worker to input selections and instructions, etc., in collaboration with display on the display 41. In the present embodiment, as described later, pressing on the function buttons 48b at positions corresponding to display buttons displayed on the display 41 enables a worker to input selections, confirmations, and instructions, etc.

The arithmetic processing unit 49 is a control arithmetic unit including, for example, at least one processor (CPU) and at least one memory (SRAM, DRAM, etc.). The arithmetic processing unit 49 outputs information on a position and a direction of the eyewear device 4 detected by the relative position sensor 45 and the relative direction sensor 46 to the data processing device 6. In addition, the arithmetic processing unit 49 displays the synchronized measurement point data 91 received from the data processing device 6 on the display 41 by superimposing the data on a site landscape.

### 4. Data Processing Device 6

The data processing device 6 is an information processing device, typically, a personal computer, a server computer, etc., and may be a tablet terminal, a smartphone, etc. In the illustrated example, the data processing device 6 is illustrated as a laptop computer. The data processing device 6 may be one computer or a computer system in which a plurality of computers dispersively perform processing, or may logically use a part of processing resources of one or more computers. The data processing device 6 corresponds to the data processing unit in the claims. The data processing device 6 may be configured as a portion of the eyewear device 4, or may be configured as a portion of the surveying instrument 2. A part of processing of the data processing device 6 may be performed by the eyewear device 4, and a part of the processing may be performed by the surveying instrument 2.

The data processing device 6 includes at least a communication unit 61, a display unit 62, an operation unit 63, a control arithmetic unit 64, and a storage unit 65.

The communication unit 61 is a communication control device such as a network adapter, a network interface card, a LAN card, or a Bluetooth adapter, and enables the data processing device 6 to communicate with the surveying instrument 2 and the eyewear device 4 by wire or wirelessly. The control arithmetic unit 64 can transmit and receive information to and from the surveying instrument 2 and the eyewear device 4 through the communication unit 61. The data processing device 6 may be installed in a local environment and communicate with the surveying instrument 2 and the eyewear device 4, or may be realized as a so-called cloud environment and communicate with the surveying instrument 2 and the eyewear device 4 through a communication network such as the Internet.

The display unit 62 is, for example, a liquid crystal display. The operation unit 63 is, for example, a keyboard, a mouse, etc., and can input various instructions, selections, and determinations, etc., by a worker.

The control arithmetic unit 64 is an arithmetic control unit including, for example, at least one processor (for example, CPU) and at least one memory (DRAM, SRAM, etc.). By reading out data and programs stored in the storage unit 65 into the memory and executing the programs by the processor, functions of the functional units can be executed. The functional units may be implemented software-wise by programs, and at least a part of the functional units may be implemented hardware-wise by a dedicated circuit.

The control arithmetic unit 64 includes, as functional units, a synchronous-measuring unit 641, a measurement point data display unit 642, the target position irradiating unit 643 and a measurement instructing unit 644.

The synchronous-measuring unit 641 receives information on a position and a direction of the surveying instrument 2 and information on a position and a direction of the eyewear device 4, converts a coordinate space of the surveying instrument 2 and a coordinate space of three-dimensional position information created in the absolute coordinate system so that these coordinate spaces match a coordinate space of the eyewear device 4 which has an origin set at a common reference point, and transmits the information to the eyewear device 4. Accordingly, the information acquired by the surveying instrument 2 and the three-dimensional position information created in the absolute coordinate system can be managed in the same coordinate space as the coordinate space of the eyewear device 4.

In the present description, the term “synchronization” means, as described above, matching coordinate spaces of information on positions and directions in devices or the measurement point data 91 with different coordinate spaces, and managing relative positions and relative directions related to the respective devices in a common coordinate space with an origin set at a common reference point.

The measurement point data display unit 642 displays a measurement point P included in the measurement point data 91 synchronized by the synchronous-measuring unit 641 on the display 41.

The target position irradiating unit 643 causes the surveying instrument 2 to drive the rotation driving units 22, 24 and the distance-measuring light transmitting unit 21a, and apply distance-measuring light as guide distance-measuring light L along a collimation optical axis toward a target position Tp calculated in consideration of three-dimensional position coordinates of the measurement point P and a target height h.

By causing the surveying instrument 2 to measure a center T of the target 80 to which the surveying instrument 2 is collimated, the measurement instructing unit 644 acquires position coordinates of the target 80 and calculates coordinates of the measurement point P. The measurement instructing unit 644 determines whether the survey result is valid by comparing coordinates of the measurement point P acquired by measurement and coordinates of the measurement point P in design data. Specifically, the survey result is determined to be valid in a case where coordinates of the measurement point P acquired by measurement match coordinates of the measurement point P in design data or a case where a difference between them is within a predetermined error range. When the survey result is valid, the guide distance-measuring light L is turned off, and the end of measurement at the measurement point P is notified. When the survey result is invalid, the measurement instructing unit 644 notifies a worker of this and urged the worker to make measurement again.

The storage unit 65 is, for example, an HDD or SSD (Solid State Drive). In the storage unit 65, the same measurement point data 91 as in the storage unit 29 of the surveying instrument 2 is stored. In the storage unit 65, when functional units of the control arithmetic unit 64 are realized as software, programs for executing the functions of the respective functional units are stored. The measurement point data 91 does not necessarily have to be stored in the storage unit 65, and the measurement point data 91 stored in the storage unit 29 of the surveying instrument 2 may be readout through the communication unit 61 and used.

### 5. Target Unit 8

Referring to FIG. 1 again, the target unit 8 includes the target 80, a support member 81 that supports the target 80, and a bubble tube 82. The target 80 is, for example, a so-called 360-degree prism configured by radially combining a plurality of triangular-pyramid-shaped prisms, and retro-reflects light incident from the entire circumference (360°) toward a direction opposite to an incident direction of the light.

The support member 81 is a pole extending to a predetermined length, and the target 80 is attached to the support member 81 so that a central axis of the support member is concentric with the target 80. A tip end 81a of the support member 81 is set at a measurement point, and a distance from the tip end 81a of the support member 81 to the center T of the target 80, that is, a target height h is known.

The bubble tube 82 is a so-called circular bubble tube. The bubble tube 82 is attached to the support member 81 or the target 80. By the worker holding the support member 81 so that a bubble is set at a center of the circle, the target 80 can be held vertically.

### 6. Survey Method (Method for Controlling the Survey System)

### 6-1 Initial Settings

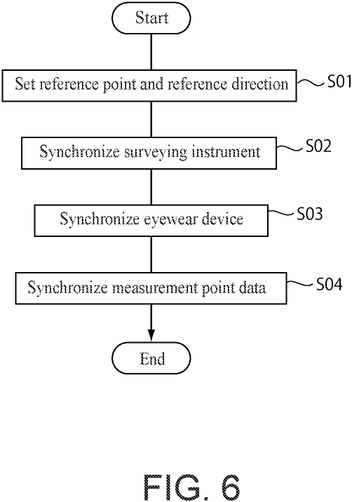

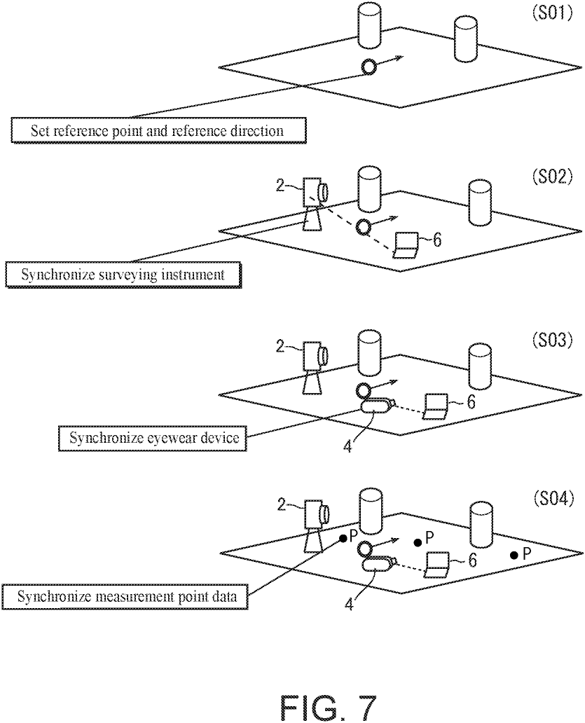

Next, a survey method using the system 100 will be described. First, as initial settings of the system 100, Steps S01 to S04 are performed. FIG. 6 is a flowchart of initial settings of the system 100, and FIG. 7 is a view illustrating an outline of the initial setting work. Prior to measurement, a target height h is known.

First, in Step S01, a worker sets a reference point and a reference direction at an observation site. As the reference point, an arbitrary point in the site is selected. As the reference direction, a characteristic point different from the reference point is arbitrarily selected, and a direction from the reference point to the characteristic point is set. Alternatively, the reference direction may be set to a direction toward the north.

Next, in Step S02, the worker synchronizes the surveying instrument 2. Specifically, the worker installs the surveying instrument 2 at an arbitrary point K at the site, and measures a target height h and an instrument height and registers these in the surveying instrument 2. Alternatively, the instrument height may be automatically measured by measurement with the telescope 2c directed vertically downward. By measurement such as backward intersection method including the reference point and the characteristic point selected in Step S01, absolute coordinates of an instrument center O of the surveying instrument 2 are grasped. The surveying instrument 2 transmits the coordinate information and the target height h to the data processing device 6.

The synchronous-measuring unit 641 converts absolute coordinates of the reference point into (x, y, z) = (0, 0, 0), and recognizes the reference direction as a horizontal angle of 0°, and subsequently, concerning information from the surveying instrument 2, manages a relative position and a relative direction of the surveying instrument 2 in a space with an origin set at the reference point.

Next, in Step S03, the worker synchronizes the eyewear device 4. Specifically, the worker installs the eyewear device 4 at the reference point, aligns a center of the display 41 with the reference direction, and sets (x, y, z) of the relative position sensor 45 to (0, 0, 0) and sets (roll, pitch, yaw) of the relative direction sensor to (0, 0, 0). Subsequently, concerning data acquired from the eyewear device 4, the synchronous-measuring unit 641 manages a relative position and a relative direction of the eyewear device 4 in a coordinate space with an origin set at the reference point common to the surveying instrument 2.

The synchronization of the eyewear device 4 is not limited to the method described above, and may be performed by, for example, providing the eyewear device 4 with a laser device for indicating a center and a directional axis of the eyewear device 4, and performing alignment with the reference point and the reference direction by using a laser as a guide.

Next, in Step S04, the synchronous-measuring unit 641 synchronizes measurement point data 91. Specifically, the measurement point data 91 is managed as three-dimensional position coordinate data in a coordinate space with an origin set at the reference point. Accordingly, the eyewear device 4 can display the measurement point P by superimposing the measurement point on a landscape of the site. That is, a worker wearing the eyewear device 4 is enabled to observe the measurement point P at a corresponding position on a site landscape observed through the display 41.

### 6-2 Survey Method

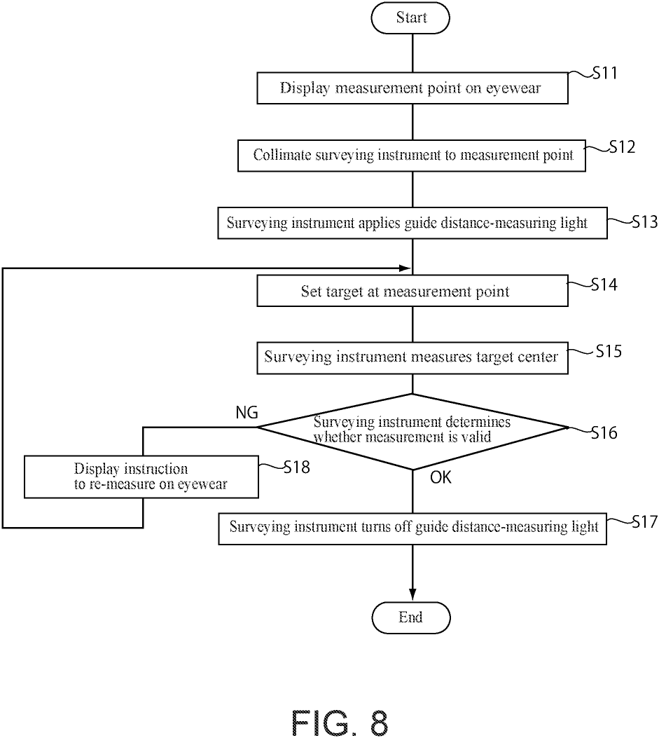

FIG. 8 is a flowchart of processing of the control arithmetic unit 64 in a survey method using the system 100. Processing starts in a state where the initial settings described above have been completed. It is assumed that a measurement point P is selected in advance before the start of the survey.

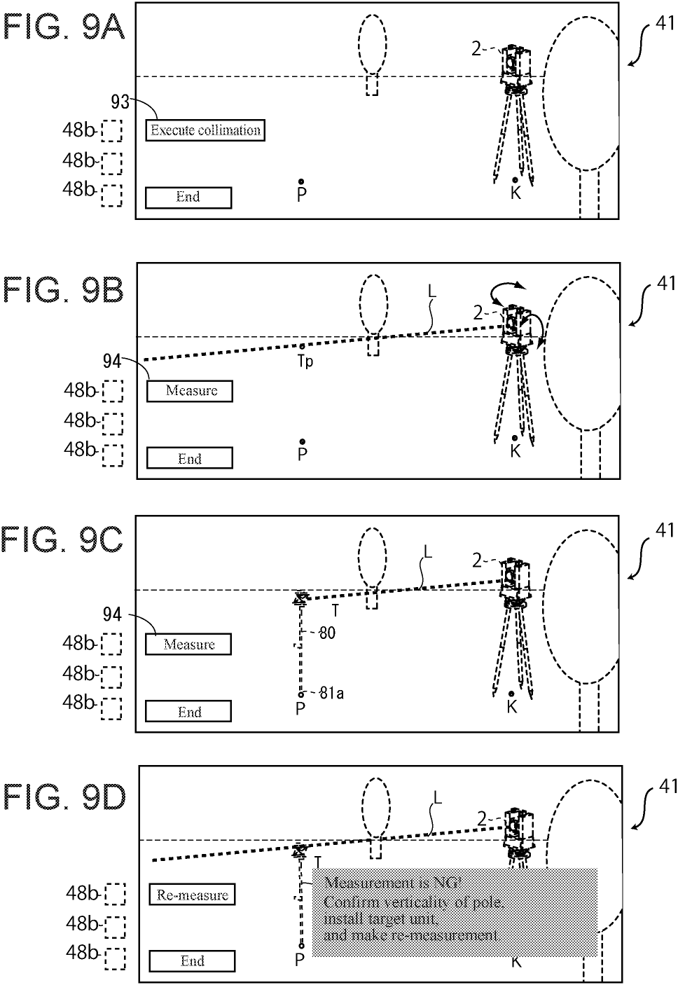

When a survey starts, in Step S11, according to an instruction of the measurement point data display unit 642, the eyewear device 4 displays the measurement point P on the display 41. FIG. 9A is a view illustrating a state where the measurement point P is displayed on the display 41. Hereinafter, in the figures illustrating display on the display 41, dashed lines represent a landscape of a survey site, and solid lines represent an image created by the data processing device 6 unless otherwise specified. For understanding, a visual field is enlarged as appropriate, and the presence of a worker is omitted in drawing.

Next, in Step S12, according to an instruction of the target position irradiating unit 643, the surveying instrument 2 is caused to drive the horizontal rotation driving unit 24 and the vertical rotation driving unit 22 to perform collimation to the measurement point P, that is, the target position Tp.

Specifically, the target position irradiating unit 643 calculates coordinates of the target position Tp from the coordinates of the measurement point P and the target height h, and directs the collimation optical axis of the surveying instrument 2 toward the target position Tp by driving the horizontal rotation driving unit 24 and the vertical rotation driving unit 22 of the surveying instrument 2. A collimation instruction may be issued by, for example, pressing on the function button 48b corresponding to a collimation execution button 93 displayed on the display 41.

Next, in Step S13, according to an instruction of the target position irradiating unit 643, the surveying instrument 2 applies guide distance-measuring light L as a visible laser beam along the collimation optical axis. Specifically, the control arithmetic unit 26 of the surveying instrument 2 controls the distance-measuring light transmitting unit 21a to output the guide distance-measuring light L. At this time, as illustrated in FIG. 9B, the guide distance-measuring light L to be irradiated on a site landscape is observed through the display 41. The target position Tp is drawn for explanation, however, the target position Tp does not need to be displayed on the actual display 41.

Next, in Step S14, as illustrated in FIG. 9C, while confirming the display on the display 41, the worker installs the target unit 8 by matching the tip end 81a of the target unit 8 with the measurement point P, and holds the target unit 8 vertically. At this time, a center T of the target 80 actually set matches the target position Tp.

Next, in Step S15, according to an instruction of the measurement instructing unit 644, the surveying instrument 2 measures a distance and angles to the center T of the target 80, and acquires position coordinates of the measurement point P. Specifically, for example, when the worker presses the function button 48b of the eyewear device 4 corresponding to a displayed measurement button 94 to transmit an instruction to make a measurement to the surveying instrument 2, the surveying instrument 2 measures a distance and angles to the center T of the target 80 and calculates three-dimensional position coordinates of the target 80, and accordingly, calculates three-dimensional position coordinates of the measurement point P.

Next, in Step S16, the measurement instructing unit 644 determines whether the survey result is valid. The measurement instructing unit 644 determines the survey result to be valid in a case where coordinates of the measurement point P acquired by measurement match coordinates of the measurement point P in design data or in a case where a difference between them is within a predetermined error range.

When the measurement result is valid (OK), the processing shifts to Step S17, and according to an instruction of the measurement instructing unit 644, the surveying instrument 2 stores the acquired coordinates of the measurement point P in the external storage device 30 of the surveying instrument 2 and controls driving of the distance-measuring light transmitting unit 21a to turn off the guide distance-measuring light L. Simultaneously, “Measurement is OK,” etc., may be displayed on the display 41. Then, the measurement at the measurement point P is completed.

In Step S16, when the measurement result is invalid (NG), the processing shifts to Step S18. As illustrated in FIG. 9D, the guide distance-measuring light L is not turned off, and “Measurement is NG” is displayed on the display 41. In addition, an instruction is displayed in which the worker is instructed to install the target unit 8 again and make re-measurement.

A possible cause of invalidity is, for example, a case where the target unit 8 is not correctly installed at the measurement point P, a case where the target unit 8 is not vertical, etc. Therefore, at the same time, a precaution for re-measurement may be notified on the display such as “Confirm verticality of the pole to install target unit, and make re-measurement.” Then, the processing returns to Step S14, and Steps S14 to S16 are repeated.

When a result of the re-measurement is invalid again in Step S16, the processing may be ended. This is because a cause of invalidity is not likely a problem with installation of the target unit 8.

According to the configuration described above, just by installing the target unit 8 so that the tip end of the target unit 8 matches the measurement point P displayed on the display 41 while observing guide distance-measuring light L through the display 41, a worker can direct the collimation direction of the surveying instrument 2 toward the target 80 set at the measurement point P. It is not necessary to perform complicated work for directing the surveying instrument 2 toward the target 80.

The above embodiment is configured so that coordinates of the measurement point acquired by measurement and coordinates of the measurement point in design are compared, and when the coordinates of the measurement point do not match the coordinates of the measurement point in design or a difference between them is outside a predetermined range, the target unit 8 is re-installed and re-measured. Therefore, a measurement error in case of inappropriate installation of the target unit 8 can be prevented.

### II. Second Embodiment

In particular, in the case of outdoor survey, a deviation may occur between the center T of the target 80 of the target unit 8 actually set at the measurement point P displayed on the eyewear device 4 and an irradiation direction of guide distance-measuring light L due to the following causes:

Due to ground sinking or uplift at the measurement point position, a position (in particular, a z-coordinate component) of the measurement point P displayed on the eyewear device 4 and a position of an actual measurement point deviate from each other, and a position of the target 80 of the target unit 8 set at the actual measurement point becomes lower or higher than the actual position.

Due to wind at the survey site, the installed surveying instrument 2 slightly tilts like a pendulum forward, backward, leftward, and rightward around the tripod as a fulcrum, and accordingly, an irradiation position deviates downward from a horizontal plane.

Due to a temperature at the survey site, heat haze or fluctuation occurs, and as a result, an irradiation position deviates in the vertical direction from a horizontal plane.

The second embodiment is configured so that such a deviation of an irradiation direction of the guide distance-measuring light L can be corrected.

### 1. Configuration of Survey System 100A

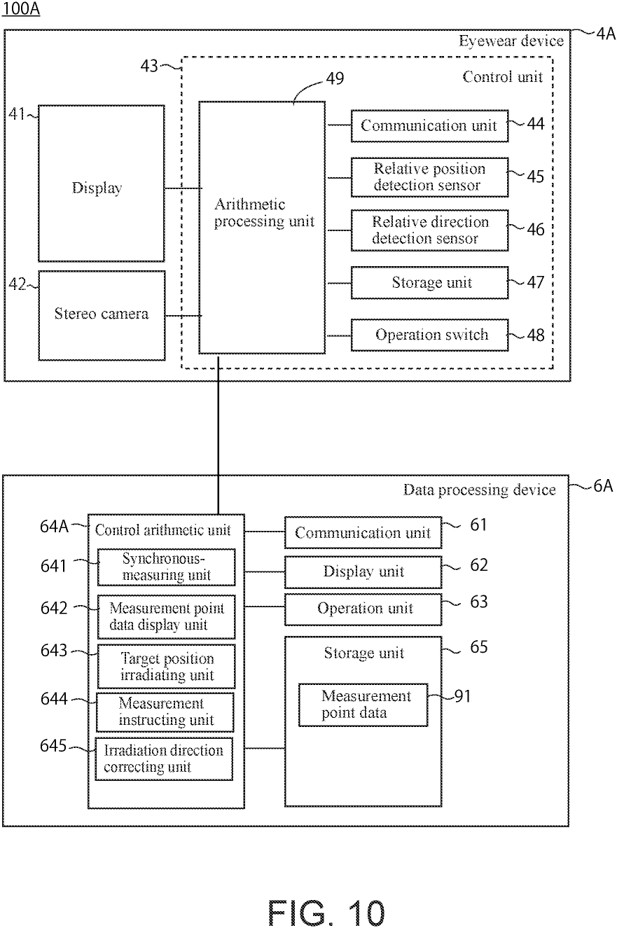

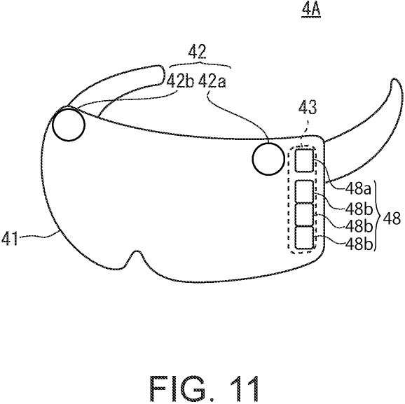

FIG. 10 is a configuration block diagram of an eyewear device 4A and a data processing device 6A of a survey system 100A according to the second embodiment. FIG. 11 is an external perspective view of the eyewear device 4A. As with the system 100, the system 100A includes, as an entire configuration, the surveying instrument 2, the eyewear device 4A, the data processing device 6A, and the target unit 8.

The eyewear device 4A has a configuration substantially similar to that of the eyewear device 4, and further includes a stereo camera 42 that acquires a front image of the eyewear device 4A.

The stereo camera 42 includes two cameras 42a and 42b disposed at upper left and right end portions on a front surface of the eyewear device 4A. Each camera 42a, 42b includes an image sensor such as a CCD or CMOS and a lens. Each image sensor has an orthogonal coordinate system having vertical and horizontal axes and an origin set at a camera center, and can acquire three-dimensional position coordinates from depth information and vertical and horizontal pixel position information within a screen by calculating distances to all characteristic points within the screen based on a parallax between the left and the right cameras. A positional relationship between a center of the stereo camera 42 and a center of the eyewear device 4A is known, and the eyewear device 4 can convert a coordinate space of an image acquired by the stereo camera 42 into a coordinate space of the eyewear device 4A and manage the image.

The data processing device 6A has a configuration substantially similar to that of the data processing device 6, but is different in that a control arithmetic unit 64A further includes an irradiation direction correcting unit 645.

When guide distance-measuring light L that the surveying instrument 2 applies by the target position irradiating unit 643 deviates from the center T of the target 80 actually set at the measurement point P, the irradiation direction correcting unit 645 drives the rotation driving units 22 and 24 of the surveying instrument 2 and corrects an irradiation direction so that the irradiation direction matches the center T of the target 80.

### 2. Survey Method (Method for Controlling the Survey System 100A)

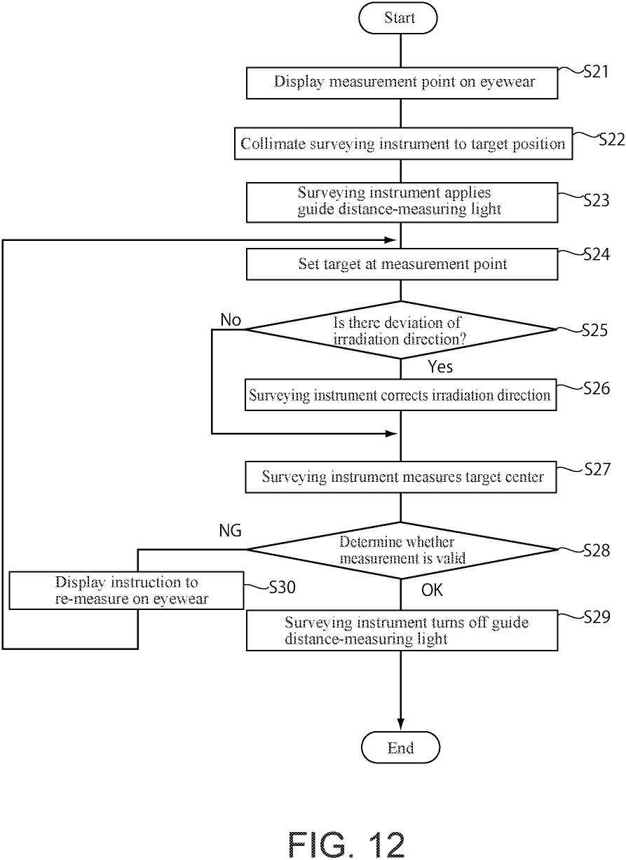

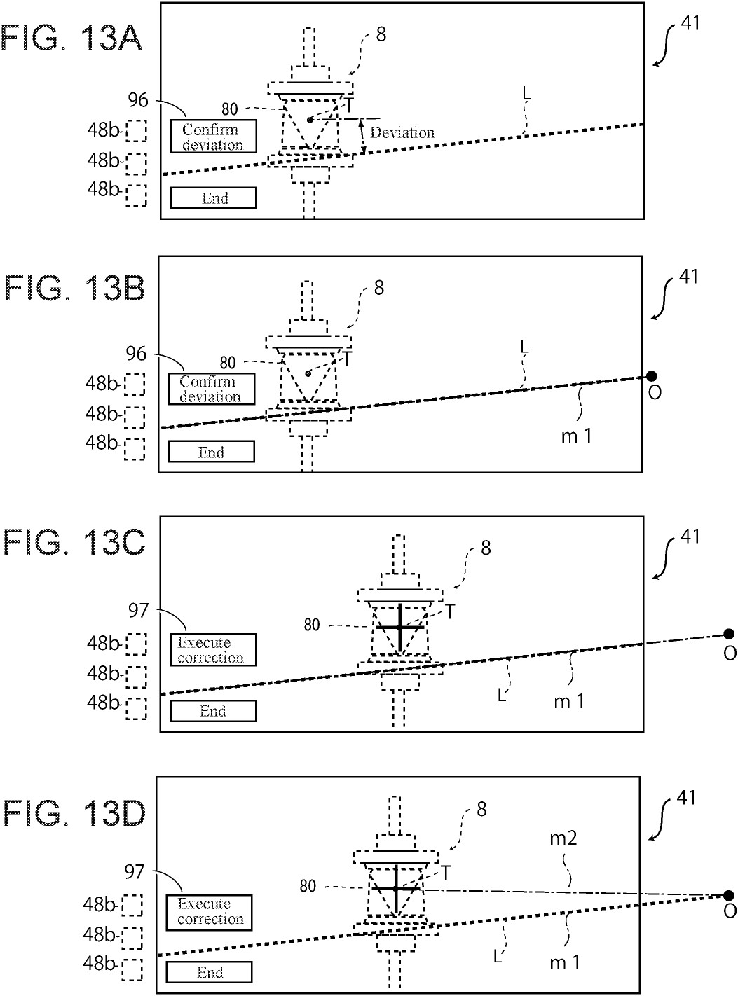

FIG. 12 is a flowchart of operation of a survey method using the system 100A, and FIGS. 13A, 13B, 13C, and 13D are views illustrating examples of display on the display of the eyewear device 4A in a survey work using the system 100A.

When the processing is started, in Steps S21 to S23, as in Steps S11 to S13, according to an instruction of the target position irradiating unit 643, the surveying instrument 2 applies guide distance-measuring light L toward the target position Tp.

Next, in Step S24, a worker installs the target unit 8 vertically so that the tip end 81a matches the measurement point P displayed on the display 41. At this time, the worker confirms whether there is a deviation between the irradiation direction of the guide distance-measuring light L and the center T of the target 80 through the display 41. For example, FIG. 13A illustrates a case where the guide distance-measuring light L deviates downward in the vertical direction, and it may also deviate in the horizontal direction. In FIGS. 13A, 13B, 13C, and 13D, explanatory items excluding projected images and a site landscape are indicated with alternate long and short dash lines.

Next, in Step S25, for example, by pressing on a function button 48b corresponding to a displayed deviation confirmation button 96, when information on the presence of the deviation is input into the control arithmetic unit 64A (Yes), the processing shifts to Step S26, and according to an instruction of the irradiation direction correcting unit 645, the surveying instrument 2 corrects the irradiation direction of the guide distance-measuring light L. In Step S25, when there is no deviation of the irradiation direction (No), the processing shifts to Step S27.

Referring to FIGS. 13A, 13B, 13C, and 13D, details of an example of irradiation direction correction will be described. When information on the presence of a deviation is input by pressing on the function button 48b corresponding to the deviation confirmation button 96 (FIGS. 13A and 13B), the irradiation direction correcting unit 645 displays a correction execution button 97 (FIGS. 13C and 13D) on the display 41. When the worker presses a function button 48b corresponding to the correction execution button 97, the irradiation direction correcting unit 645 enables acquisition of an image including the guide distance-measuring light L with the stereo camera 42. The eyewear device 4A acquires an image including the guide distance-measuring light L by the stereo camera 42 according to an instruction of the worker. Next, the irradiation direction correcting unit 645 extracts the guide distance-measuring light L from the image by pattern matching, and calculates a formula for a line m1 of the guide distance-measuring light L passing through the instrument center O in a synchronized coordinate space with an origin set at the reference point.

Next, the irradiation direction correcting unit 645 displays a reticle at a center of the display 41 as illustrated in FIG. 13C. This reticle is matched with the center T of the target 80 and imaging is performed with the stereo camera 42, and position coordinates of the center T of the target 80 in the synchronized coordinate space are calculated. Then, the irradiation direction correcting unit 645 calculates a formula for a line m2 (FIG. 13D) passing through the instrument center O and the center T of the target 80 in the synchronized coordinate space with the origin set at the reference point. The line m1 and the line m2 cross at the instrument center O. Thus, the line m1 and the line m2 are found to deviate from each other in the horizontal and vertical directions around the instrument center O.

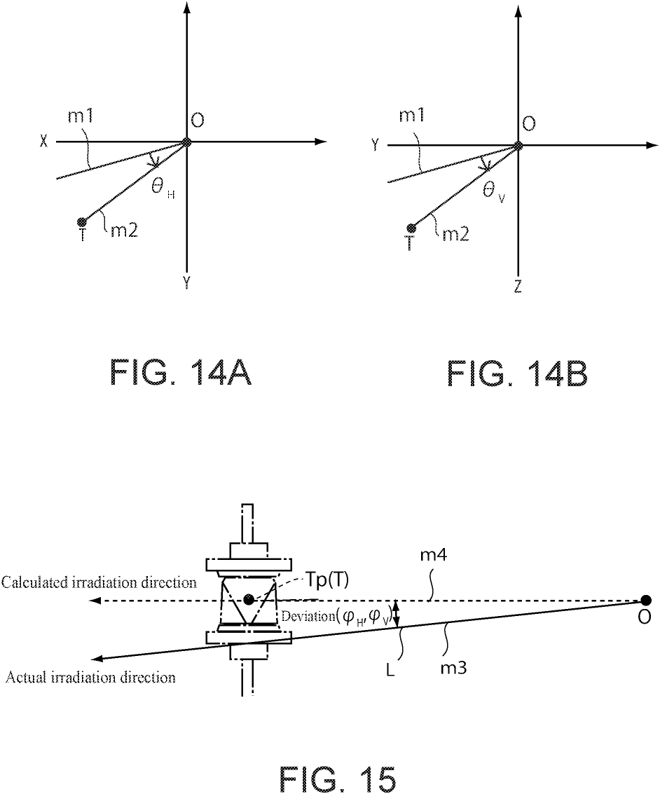

Next, a deviation between the line m1 and the line m2 around the instrument center O is calculated provided that θ_{H} is a horizontal angle deviation and θ_{V} is a vertical angle deviation. FIG. 14A is a diagram describing a horizontal angle deviation θ_{H} and FIG. 14B is a diagram describing a vertical angle deviation θ_{V}. By using the calculated horizontal angle and vertical angle deviations θ_{H} and θ_{V} as correction values, the irradiation direction correcting unit 645 corrects the irradiation direction by driving the rotation driving units 22 and 24 of the surveying instrument 2 so that the center T of the target 80 is irradiated with the guide distance-measuring light L.

Alternatively, although not illustrated in the figures, it is also possible that the irradiation direction correcting unit 645 is configured to remotely control the rotation driving units 22 and 24 of the surveying instrument 2 according to an operation of the function button 48b of the eyewear device 4A so that the center T of the target 80 is irradiated with the guide distance-measuring light L. With this configuration, the worker can make adjustment so that the center T of the target 80 is irradiated with the guide distance-measuring light L by operating the function button 48b at a position corresponding to a remote operation button while confirming the guide distance-measuring light L and the center T of the target 80 through the display 41.

Next, in Step S27, according to an instruction of the measurement instructing unit 644, the surveying instrument 2 measures the target 80 and acquires position coordinates of the measurement point P.

Subsequently, in Steps S28 to S30, as in Steps S16 to S18, whether the measurement result is valid is determined, and when the result is OK, the measurement is completed. When the result is NG, the processing returns to Step S24, and the target unit 8 is installed again and the measurement is repeated.

According to the configuration described above, even when there is a positional deviation between the measurement point P in design and a position of the actual measurement point P or when the irradiation direction of the guide distance-measuring light L deviates due to an environmental factor such as a temperature and wind, the deviation between the guide distance-measuring light L and a calculated target position Tp can be corrected and the surveying instrument 2 can be directed toward the center of the target 80 actually set at the measurement point P.

### III. Third Embodiment

As described in the second embodiment above, when the surveying instrument 2 applies guide distance-measuring light L toward the target position Tp based on coordinates of the measurement point P in design, an actual irradiation direction of the guide distance-measuring light L deviates from the target position Tp in some cases due to influences from atmospheric motions and heat haze, etc., occurring in relation to a temperature. The irradiation direction also deviates due to wind in some cases. Describing again with reference to FIG. 15, the guide distance-measuring light L output from the instrument center O of the surveying instrument 2, indicated with a line m3, is output toward the target position Tp calculated from coordinates of the measurement point P in design and the target height h. However, an actual irradiation direction deviates in the horizontal direction and the vertical direction around the instrument center O from the target position Tp as indicated by a line m4.

In the second embodiment 2, first, the surveying instrument 2 is caused to irradiate a calculated target position Tp. After confirming a deviation between an actual irradiation direction of the guide distance-measuring light L and the center T of the target 80 by using the eyewear device 4, the surveying instrument 2 is caused to drive the rotation driving units 22 and 24 for correction to eliminate the deviation. By contrast, in the present embodiment, a deviation that will occur is calculated in advance. And when the surveying instrument 2 is directed toward the target position Tp according to an instruction of the target position irradiating unit 643, in consideration of the deviation as a correction value, the rotation driving units 22 and 24 of the surveying instrument 2 are driven.

### 1. System 100B

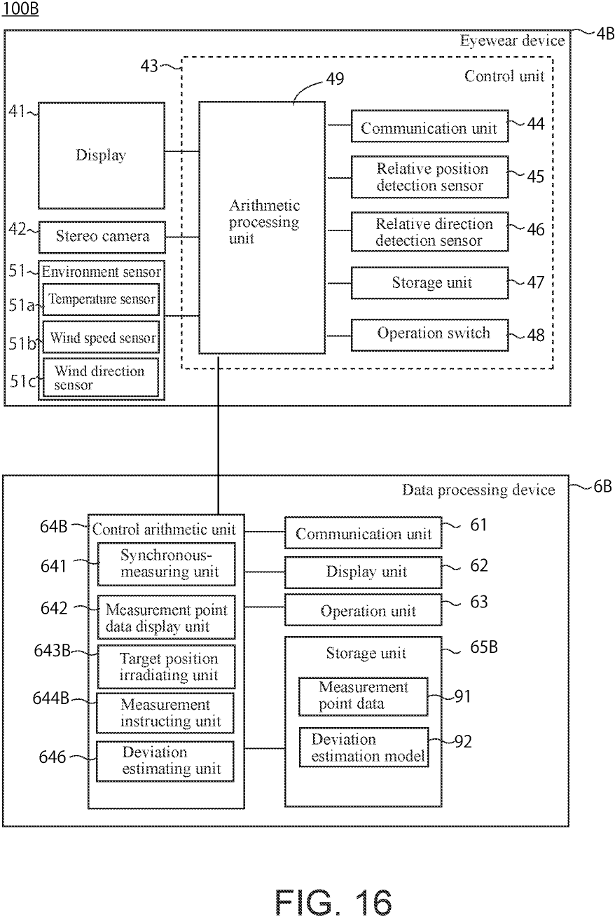

FIG. 16 is a configuration block diagram of an eyewear device 4B and a data processing device 6B constituting a system 100B according to the third embodiment. As with the systems 100 and 100A, the system 100B includes the surveying instrument 2, the eyewear device 4B, the data processing device 6B, and the target unit 8.

The eyewear device 4B has a configuration similar to that of the eyewear device 4A, but is different in that the eyewear device 4B further includes an environment sensor 51. The environment sensor 51 includes a temperature sensor 51a, a wind speed sensor 51b, and a wind direction sensor 51c. A wind direction is measured in all directions of 360° based on the true north, and can be converted into an absolute coordinate system common to the reference point, etc., and is input as a horizontal angle with respect to a posture of the surveying instrument 2 into the data processing device 6. Environment data acquired by the environment sensor 51 is output by the arithmetic processing unit 49 to a control arithmetic unit 64B of the data processing device 6B through the communication unit 44. The environment sensor 51 may include not only the temperature sensor 51a, the wind speed sensor 51b, and the wind direction sensor 51c, but also a sensor that detects an environmental factor known to influence an irradiation direction of distance-measuring light.

The control arithmetic unit 64B of the data processing device 6B includes a deviation estimating unit 646 in addition to components of the control arithmetic unit 64, and includes a target position irradiating unit 643B instead of the target position irradiating unit 643, a measurement instructing unit 644B instead of the measurement instructing unit 644, and a storage unit 65B instead of the storage unit 65.

The deviation estimating unit 646 estimates a deviation between a calculated irradiation direction and an actual irradiation direction of guide distance-measuring light L, caused by an environmental factor.

Deviation estimation is performed by, for example, using a deviation estimation model 92 created as follows.

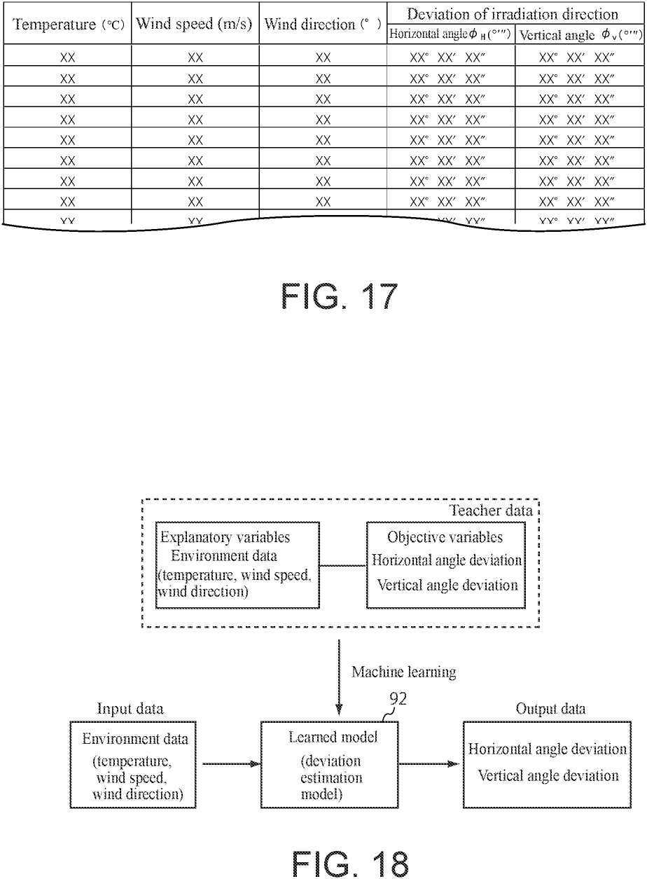

By using, for example, data acquired by using the system 100B, the deviation estimation model 92 is generated as follows with a deviation estimation model generating device (not illustrated) as a computer having the same hardware configuration as that of the data processing device 6. Specifically, the target 80 is installed at the known point (in this case, a calculated target center position Tp is matched with the center T of the target 80), and a deviation between a calculated irradiation direction of guide distance-measuring light L and an actual irradiation direction of the guide distance-measuring light L observed through the eyewear device 4A is measured under various temperature, wind speed, and wind direction conditions. Like the deviation between the line m1 and the line m2 in the second embodiment, as a deviation of the irradiation direction, a deviation between a calculated irradiation direction of guide distance-measuring light passing through the instrument center O and a line m4 of an actual irradiation direction passing through the instrument center O in a coordinate space synchronized with the eyewear device 4A is calculated as a horizontal angle deviation ϕ_{H} and a vertical angle deviation ϕ_{V} around the instrument center O, respectively. Data acquired in this way is an example of teacher data illustrated in FIG. 17.

As illustrated in outline in FIG. 18, machine learning is performed by using, as teacher data, a data set including the environment data (temperature and wind speed values) as explanatory variables and the horizontal angle deviation ϕ_{H} and the vertical angle deviation ϕ_{V} as objective variables, and by using the temperature and wind speed values acquired by the eyewear device 4B as input data, a learned model (deviation estimation model 92) for estimating, as output data, horizontal angle and vertical angle deviations between the calculated irradiation direction of the guide distance-measuring light L and the actual irradiation direction under these conditions, is generated.

Machine learning is realized by, for example, a neural network using one or a plurality of layers of nonlinear units for estimating an output with respect to an input, and specifically, methods of DNN (Deep Neural Network), CNN (Convolutional Neural Network), and RNN (Recurrent Neural Network) can be used. For machine learning, a method of SVR (Support Vector Regression), random forest, or Bayesian linear regression analysis, etc., may be used.

The deviation estimating unit 646 calculates a deviation of the irradiation direction of the guide distance-measuring light L under environment conditions of the site by receiving environment data from the eyewear device 4B and inputting the environment data into the deviation estimation model 92.

The deviation estimation model 92 does not necessarily have to be generated by machine learning, and a model formula for estimating a deviation may be generated by a known statistical method.

The target position irradiating unit 643B drives the rotation driving units 22 and 24 of the surveying instrument 2 so that the collimation direction of the surveying instrument 2 is set to a direction offset to an opposite side by the deviation (horizontal angle deviation ϕ_{H} and vertical angle deviation ϕ_{V}) calculated by the deviation estimating unit 646 from a horizontal angle and a vertical angle for directing toward the calculated target position Tp, and applies the guide distance-measuring light L along the collimation optical axis. Specifically, when the deviation includes a horizontal angle deviation of -2″ and a vertical angle deviation of +1″, the irradiation direction of the distance-measuring light is changed by +2″ in horizontal angle and -1″ in vertical angle, and the guide distance-measuring light L is applied.

When the measurement instructing unit 644B causes the surveying instrument 2 to measure the center T of the target 80 to acquire position coordinates of the target 80, and calculate coordinates of the measurement point P, the measurement instructing unit 644B causes the surveying instrument 2 to calculate coordinates of the measurement point P in consideration of horizontal angle and vertical angle deviations. Specifically, when the horizontal angle deviation is -2″ and the vertical angle deviation is +1″, angles are calculated by adding a horizontal angle of -2″ and a vertical angle of +1″ to measured angle values, and accordingly, position coordinates of the measurement point P are calculated.

The storage unit 65B stores the deviation estimation model 92 in addition to those stored in the storage unit 65.

### 2. Survey Method (Method for Controlling the Survey System)

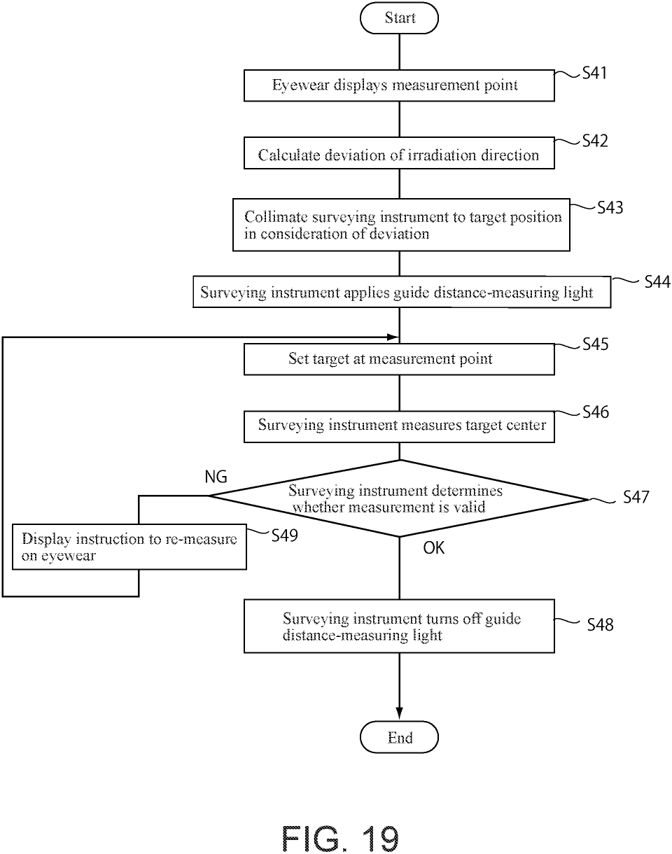

FIG. 19 is a flowchart of a survey method using the system 100B.

When a survey starts, in Step S41, as in Step S11, according to an instruction of the measurement point data display unit 642, the eyewear device 4B displays the measurement point P on the display 41.

Next, in Step S42, the deviation estimating unit 646 acquires environment data from the eyewear device 4B and inputs the environment data into the deviation estimation model 92, and calculates a deviation between a calculated irradiation direction and an actual irradiation direction of the guide distance-measuring light L, caused by an environmental factor.

Next, in Step S43, according to an instruction of the target position irradiating unit 643B, the surveying instrument 2 is collimated to a target position set in consideration of the deviation calculated by the deviation estimating unit 646 with respect to a horizontal angle and a vertical angle for directing the surveying instrument 2 toward a calculated target position Tp.

Next, in Step S44, according to an instruction of the target position irradiating unit 643B, the rotation driving units 22 and 24 of the surveying instrument 2 are driven to apply guide distance-measuring light L along the collimation optical axis.

Next, in Step S45, the worker installs the target unit 8 at the measurement point P while confirming the measurement point P displayed on the display 41, and in Step S46, according to an instruction of the measurement instructing unit 644B, the surveying instrument 2 is caused to measure the center T of the target 80 and calculate position coordinates of the measurement point P in consideration of the deviation of the irradiation direction.

Subsequently, in Steps S47 to S49, as in Steps S16 to S18, whether the measurement result is valid is determined, and in a case of OK, the measurement is completed. In a case of NG, the processing returns to Step S45, and the target unit 8 is installed again and the measurement is repeated.

In the configuration described above, the survey system 100B estimates in advance a deviation of the irradiation direction of the guide distance-measuring light L caused by an environmental factor such as a temperature, a wind speed, and applies the guide distance-measuring light L in a direction in consideration of the deviation. According to the configuration described above, in addition to an effect equivalent to the effect of the system 100 according to the first embodiment, a further effect of exactly collimating the surveying instrument 2 to the target position Tp even when the irradiation direction of the guide distance-measuring light L deviates due to an environmental factor such as a temperature and wind, can also be obtained.

### 3. Modification

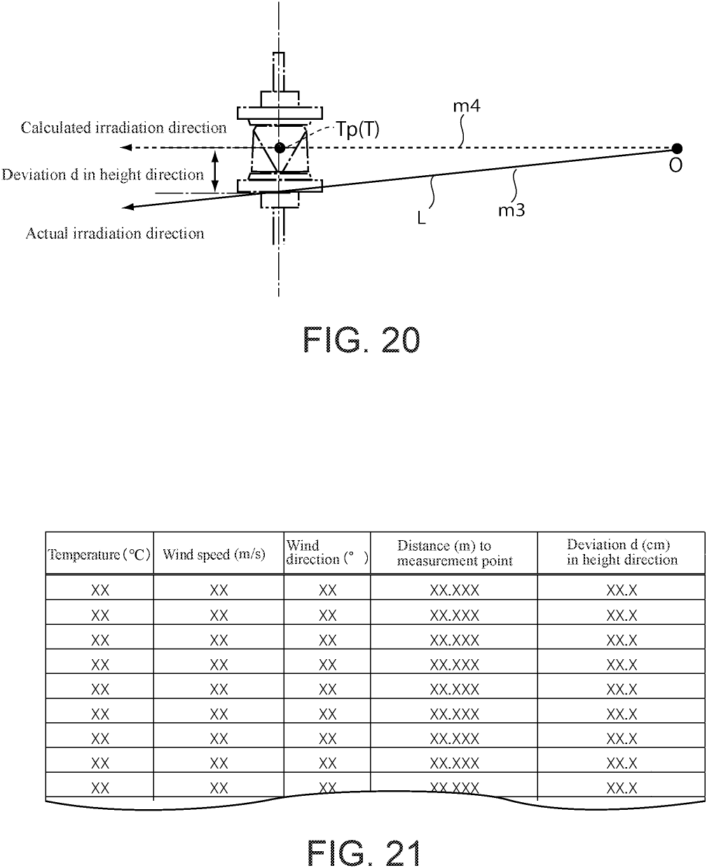

As a modification of the present embodiment, a deviation estimation model 92A may be used instead of the deviation estimation model 92. In the deviation estimation model 92A, a deviation between a calculated irradiation direction and an actual irradiation direction is recognized as a deviation d in a height direction between the target position Tp and an irradiation position of the guide distance-measuring light on the same vertical line as illustrated in FIG. 20.

Therefore, by using the survey system having a configuration similar to that of the system 100B, a deviation in a height direction between a calculated irradiation direction of guide distance-measuring light and an actual irradiation direction is measured under various temperature, wind speed, and wind direction conditions, and a distance to the target center T (distance from the instrument center O to the target position Tp. The target center T set vertically at the known point is equal to the target position Tp) is calculated, and accordingly, data are collected as illustrated in FIG. 21. A deviation in the height direction can be measured by using the eyewear device 4A.

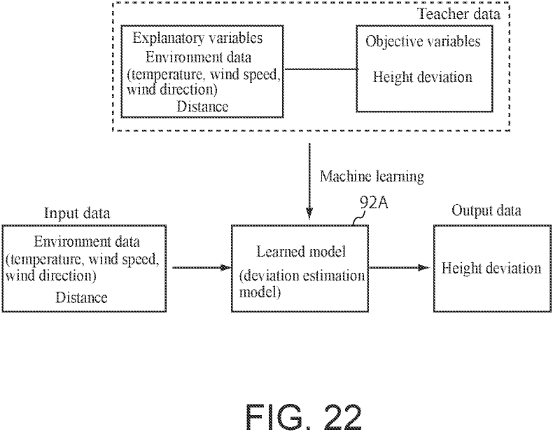

As illustrated in outline in FIG. 22, machine learning as in generation of the deviation estimation model 92 is performed by using, as teacher data, a data set including the environment data (temperature and wind speed values) and the distance to the target center as explanatory variables and the deviation in the height direction as an objective variable, and by using temperature and wind speed values acquired by the eyewear device 4 as input data, a learned model (deviation estimation model 92) for estimating, as output data, a deviation of a height of an irradiation position of the guide distance-measuring light L under these conditions is generated. A deviation estimating unit 646B1 (not illustrated) calculates a distance from the instrument center O to the center T of the target 80, and by inputting this distance and environment data received from the environment sensor of the eyewear device 4B into the deviation estimation model 92A, estimates a deviation of the irradiation direction.

This can also realize the same configuration as that of the system 100B according to the third embodiment described above.

### IV. Fourth Embodiment

In a measurement with a total station, it is preferable to use the collimation optical axis of the telescope horizontal because this facilitates the measurement. Therefore, in a system 100C according to a fourth embodiment, when a variable length type target unit 8C is used, a target height that makes the collimation optical axis of the telescope horizontal or as horizontal as possible is proposed.

### 1. Survey System 100C

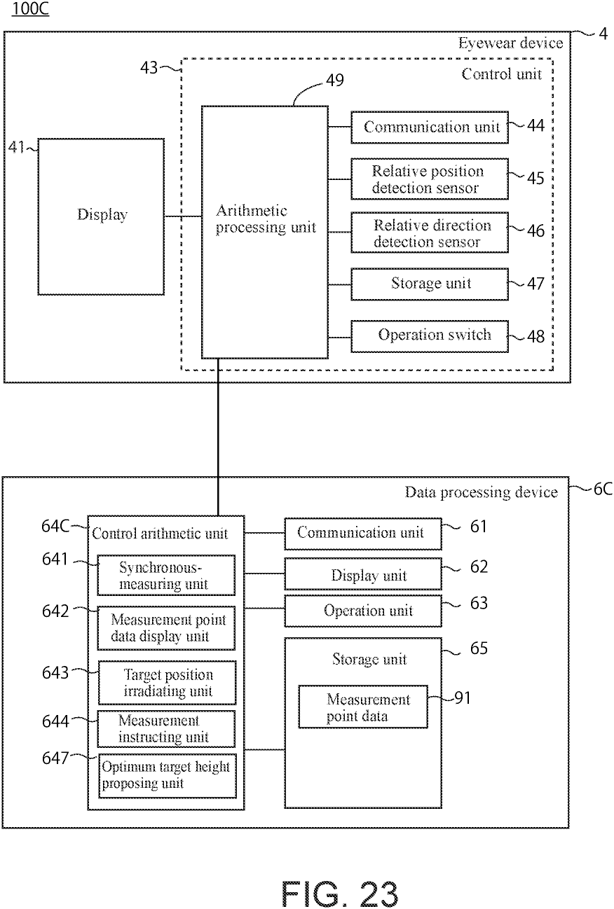

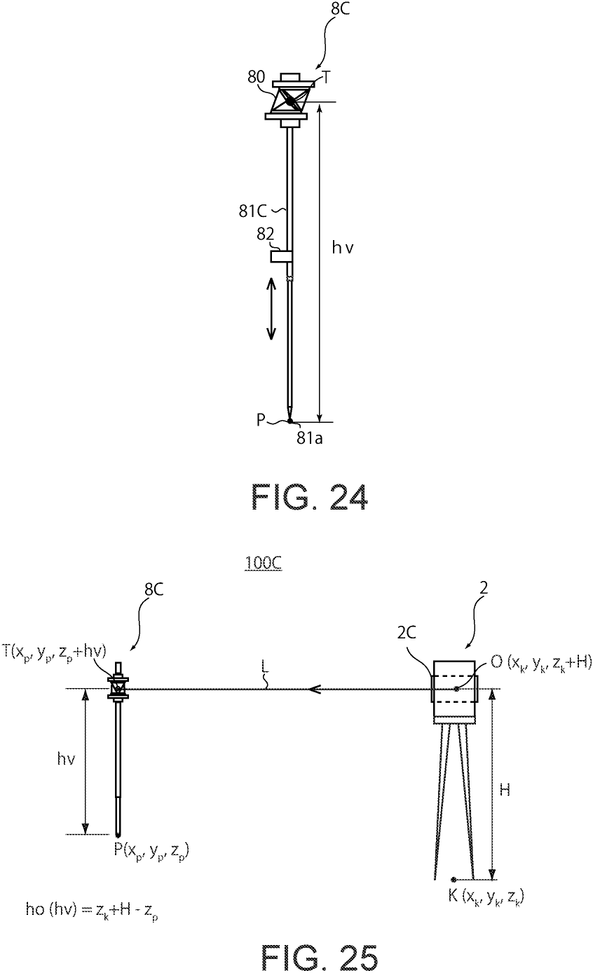

The system 100C includes, like the system 100, as an entire configuration, the surveying instrument 2, the eyewear device 4, a data processing device 6C, and the target unit 8C. FIG. 23 is a configuration block diagram of the eyewear device 4 and the data processing device 6C, and FIG. 24 is an external schematic view of the target unit 8C.

The target unit 8C includes a support member 81C that is an extensible pole and can be fixed at an arbitrary target height hv.

An optimum target height proposing unit 647 calculates a target height hv as an optimum target height ho that, when the surveying instrument 2 is collimated to the target center T, makes a collimation direction horizontal or as horizontal as possible, and displays the target height hv on the display of the eyewear device 4.

FIG. 25 is a view describing an optimum target height ho. In a case where the target unit 8C is installed at the measurement point P, when coordinates of the measurement point P are defined as P (xp, yp, zp), coordinates of the target center T can be expressed as T (xp, yp, zp+hv). When a height of the collimation optical axis is defined as H, and coordinates of the known point K are defined as K (xk, yk, zk), coordinates of the instrument center O can be expressed as O (xk, yk, zk+H).

The collimation optical axis being horizontal means:

$$\text{zy + hv = zk + H}$$

Therefore, the optimum target height ho can be obtained by:

$$\text{ho} \left(\text{hv}\right) = \text{zk + H - hv}$$

Here, provided that a maximum length of the support member 81C of the target unit 8C is defined as hvₘₐₓ, and a minimum length of the support member 81C is defined as hvₘᵢₙ,

$${\text{when hv}}_{\text{max}} < {\text{hv, ho = hv}}_{\text{max}}$$

$$\text{when hv} < {\text{hv}}_{\text{min}} {\text{, ho = hv}}_{\text{min}}$$

Therefore, based on the equations given above, the optimum target height ho can be obtained as:

$${\text{when hv}}_{\text{min}} \leq \text{hv} \leq {\text{hv}}_{\text{max}} , \text{ho = zk + H - hv}$$

$${\text{when hv}}_{\text{max}} < {\text{hv, ho = hv}}_{\text{max}}$$

$$\text{when hv} < {\text{hv}}_{\text{min}} {\text{, ho = hv}}_{\text{min}}$$

The optimum target height proposing unit 647 displays the calculated optimum target height ho on the display 41 of the eyewear device 4.

### 2. Survey Method

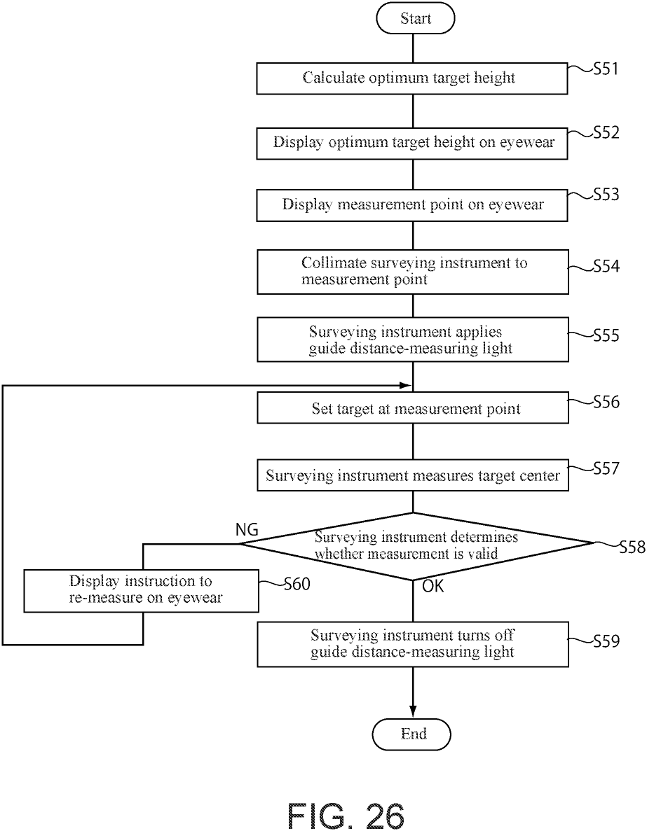

FIG. 26 is a flowchart of a survey method using the system 100C. In this method, the maximum length hvₘₐₓ and the minimum length hvₘᵢₙ of the support member 81C of the target unit 8C are registered in advance in the control arithmetic unit 64C.

When processing starts, in Step S51, the optimum target height proposing unit 647 calculates an optimum target height ho by using Equations (5) to (7).

Next, in Step S52, the optimum target height proposing unit 647 displays the optimum target height ho on the display 41. Accordingly, a worker adjusts the length of the target unit 8C according to the optimum target height ho, and fixes the length. Then, in Steps S53 to S60, processing is executed in the same manner as in Steps S11 to S18.

According to the configuration described above, when a variable length type target unit 8C is used, an optimum target height ho is proposed on the display of the eyewear device 4, so that worker’s labor for adjusting the target height ho can be significantly saved.

Preferred embodiments of the present invention have been described above, and the embodiments described above are just examples of the present invention, and can be combined based on the knowledge of a person skilled in the art, and such a combined embodiment is also included in the scope of the present invention.

Reference Signs List

| | |
|---|---|
| 2: | Surveying instrument |
| 2c: | Telescope |
| 4, 4A, 4B: | Eyewear device |
| 6, 6A, 6B, 6C: | Data processing device (data processing unit) |
| 8, 8C: | Target unit |
| 21a: | Distance-measuring light transmitting unit |
| 21b: | Distance-measuring light receiving unit |
| 22: | Vertical rotation driving unit (rotation driving unit) |
| 24: | Horizontal rotation driving unit (rotation driving unit) |
| 26: | Control arithmetic unit |
| 41: | Display |
| 42: | Stereo camera |
| 45: | Relative position sensor |
| 46: | Relative direction sensor |
| 51: | Environment sensor |
| 64, 64A, 64B, 64C: | Control arithmetic unit |
| 80: | Target |
| 81, 81C: | Support member |
| 92: | Deviation estimation model |
| 100, 100A, 100B, 100C: | Survey system |
| 641: | Synchronous-measuring unit |
| L: | Guide distance-measuring light |

1. A survey system comprising:
a target unit including a target and a support member configured to support the target;
a surveying instrument including a telescope and configured to drive and rotate the telescope in a vertical direction and a horizontal direction to transmit distance-measuring light along a collimation optical axis of the telescope to the target and receive reflected distance-measuring light from the target to measure a distance to the target, and configured to detect a collimation direction of the telescope so as to measure an angle of the target, so as to acquire three-dimensional position coordinates of the target;
an eyewear display device including a display, a relative position sensor configured to detect a position, and a relative direction sensor configured to detect a direction; and
a processor configured to match a coordinate space of information on a position and a direction acquired by the eyewear display device, a coordinate space of the surveying instrument, and a coordinate space of an absolute coordinate system, to enable information on a position and direction of the eyewear display device, the surveying instrument and data created in the absolute coordinate system to be managed in a common space with an origin set at a common reference point, wherein
the processor is configured to cause the eyewear display device to display a measurement point set as coordinates in the absolute coordinate system on the display by superimposing the measurement point on a landscape of a survey site, and cause the surveying instrument to irradiate a target position set at the measurement point, calculated in consideration of three-dimensional position coordinates of the measurement point and a target height, with the distance-measuring light as guide distance-measuring light, and
in a state where an irradiation direction of the guide distance-measuring light and a center of the target actually set at the measurement point are matched, the surveying instrument is caused to measure the center of the target.

2. The survey system according to claim 1, wherein the processor is configured to correct the irradiation direction so that the irradiation direction of the guide distance-measuring light matches the center of the target actually set at the measurement point when the guide distance-measuring light deviates from the center of the target.

3. The survey system according to claim 2, further comprising:
a stereo camera configured to acquire a front image of the eyewear display device, wherein
when the guide distance-measuring light deviates from the center of the target actually set at the measurement point,
the processor
acquires an image including the guide distance-measuring light by the stereo camera, and calculates a formula for a line of guide distance-measuring light passing through an instrument center of the surveying instrument in the space with the origin set at the common reference point,
calculates position coordinates of the center of the target in a site landscape in the space with the origin set at the common reference point by the stereo camera, calculates a formula for a line passing through the instrument center and the center of the target in the space, calculates a deviation around the instrument center between the two lines as horizontal angle and vertical angle deviations, and corrects the irradiation direction based on the horizontal angle and vertical angle deviations.

4. The survey system according to claim 1, wherein
the processor is configured to estimate in advance a deviation of the guide distance-measuring light from the center of the target actually set at the measurement point, and
in consideration of the estimated deviation, the deviation estimating unit causes the surveying instrument to irradiate the target position set at the measurement point, calculated in consideration of three-dimensional position coordinates of the measurement point and a target height, with the distance-measuring light as guide distance-measuring light.

5. The survey system according to claim 2, wherein
the processor is configured to estimate in advance a deviation of the guide distance-measuring light from the center of the target actually set at the measurement point, and
in consideration of the estimated deviation, the deviation estimating unit causes the surveying instrument to irradiate the target position set at the measurement point, calculated in consideration of three-dimensional position coordinates of the measurement point and a target height, with the distance-measuring light as guide distance-measuring light.

6. The survey system according to claim 3, wherein
the processor is configured to estimate in advance a deviation of the guide distance-measuring light from the center of the target actually set at the measurement point, and
in consideration of the estimated deviation, the deviation estimating unit causes the surveying instrument to irradiate the target position set at the measurement point, calculated in consideration of three-dimensional position coordinates of the measurement point and a target height, with the distance-measuring light as guide distance-measuring light.

7. The survey system according to claim 4, wherein
the eyewear display device further includes an environment sensor,
the processor inputs environment data acquired by the environment sensor into a deviation estimation model to estimate horizontal angle and vertical angle deviations between a calculated irradiation direction and an actual irradiation direction of the guide distance-measuring light under environment conditions of a site, and
the deviation estimation model is generated by performing machine learning by using, as teacher data, a data set including environment data as explanatory variables and horizontal angle and vertical angle deviations around an instrument center between a calculated irradiation direction and an actual irradiation direction of the guide distance-measuring light as objective variables.

8. The survey system according to claim 5, wherein
the eyewear display device further includes an environment sensor,
the processor inputs environment data acquired by the environment sensor into a deviation estimation model to estimate horizontal angle and vertical angle deviations between a calculated irradiation direction and an actual irradiation direction of the guide distance-measuring light under environment conditions of a site, and
the deviation estimation model is generated by performing machine learning by using, as teacher data, a data set including environment data as explanatory variables and horizontal angle and vertical angle deviations around an instrument center between a calculated irradiation direction and an actual irradiation direction of the guide distance-measuring light as objective variables.

9. The survey system according to claim 6, wherein
the eyewear display device further includes an environment sensor,
the processor inputs environment data acquired by the environment sensor into a deviation estimation model to estimate horizontal angle and vertical angle deviations between a calculated irradiation direction and an actual irradiation direction of the guide distance-measuring light under environment conditions of a site, and
the deviation estimation model is generated by performing machine learning by using, as teacher data, a data set including environment data as explanatory variables and horizontal angle and vertical angle deviations around an instrument center between a calculated irradiation direction and an actual irradiation direction of the guide distance-measuring light as objective variables.

10. The survey system according to claim 4, wherein
the eyewear display device further includes an environment sensor,
the processor inputs environment data acquired by the environment sensor and a calculated distance to the target position into an estimation model to estimate a deviation in a height direction between a calculated irradiation position of the guide distance-measuring light and an actual irradiation direction under environment conditions of a site, and
the deviation estimation model is generated by performing machine learning by using, as teacher data, a data set including the environment data and the calculated distance to the target position as explanatory variables and a deviation in a height direction between the target position and guide distance-measuring light as an objective variable.

11. The survey system according to claim 5, wherein
the eyewear display device further includes an environment sensor,
the processor inputs environment data acquired by the environment sensor and a calculated distance to the target position into an estimation model to estimate a deviation in a height direction between a calculated irradiation position of the guide distance-measuring light and an actual irradiation direction under environment conditions of a site, and
the deviation estimation model is generated by performing machine learning by using, as teacher data, a data set including the environment data and the calculated distance to the target position as explanatory variables and a deviation in a height direction between the target position and guide distance-measuring light as an objective variable.

12. The survey system according to claim 6, wherein
the eyewear display device further includes an environment sensor,
the processor inputs environment data acquired by the environment sensor and a calculated distance to the target position into an estimation model to estimate a deviation in a height direction between a calculated irradiation position of the guide distance-measuring light and an actual irradiation direction under environment conditions of a site, and
the deviation estimation model is generated by performing machine learning by using, as teacher data, a data set including the environment data and the calculated distance to the target position as explanatory variables and a deviation in a height direction between the target position and guide distance-measuring light as an objective variable.

13. The survey system according to claim 4, wherein the environment sensor includes a temperature sensor, a wind speed sensor, and a wind direction sensor.

14. The survey system according to claim 7, wherein the environment sensor includes a temperature sensor, a wind speed sensor, and a wind direction sensor.

15. The survey system according to claim 10, wherein the environment sensor includes a temperature sensor, a wind speed sensor, and a wind direction sensor.

16. The survey system according to claim 1, wherein
in the target unit, the support member is a variable length type, and
the processor is configured to calculate, when the surveying instrument is collimated to a target center, a target height as an optimum target height that makes a collimation direction horizontal or as horizontal as possible, and displays the calculated target height on the display.

17. The survey system according to claim 2, wherein
in the target unit, the support member is a variable length type, and
the processor is configured to calculate, when the surveying instrument is collimated to a target center, a target height as an optimum target height that makes a collimation direction horizontal or as horizontal as possible, and displays the calculated target height on the display.

18. The survey system according to claim 3, wherein
in the target unit, the support member is a variable length type, and
the processor is configured to calculate, when the surveying instrument is collimated to a target center, a target height as an optimum target height that makes a collimation direction horizontal or as horizontal as possible, and displays the calculated target height on the display.

19. The survey system according to claim 4, wherein
in the target unit, the support member is a variable length type, and
the processor is configured to calculate, when the surveying instrument is collimated to a target center, a target height as an optimum target height that makes a collimation direction horizontal or as horizontal as possible, and displays the calculated target height on the display.

20. A method for controlling a survey system including
a target unit including a target and a support member configured to support the target,
a surveying instrument including a telescope and configured to drive and rotate the telescope in a vertical direction and a horizontal direction, and transmit distance-measuring light along a collimation optical axis of the telescope to the target a distance-measuring light and receive reflected distance-measuring light from the target, to measure a distance to the target, and configured to detect a collimation direction of the telescope to measure an angle of the target, so as to acquire three-dimensional position coordinates of the target,
an eyewear display device including a display, a relative position sensor configured to detect a position, and a relative direction sensor configured to detect a direction, and
a processor configured to match a coordinate space of information on a position and a direction acquired by the eyewear display device, a coordinate space of the surveying instrument, and a coordinate space of an absolute coordinate system, to enable information on a position and direction of the eyewear display device, the surveying instrument and data created in the absolute coordinate system to be managed in a common space with an origin set at a common reference point, the method comprising:
causing the eyewear display device to display a measurement point set as coordinates in the absolute coordinate system on the display by superimposing the measurement point on a landscape of a survey site;
causing the surveying instrument to irradiate a target position set at the measurement point, calculated in consideration of three-dimensional position coordinates of the measurement point and a target height, with the distance-measuring light as guide distance-measuring light; and
in a state where an irradiation direction of the guide distance-measuring light and a center of the target actually set at the measurement point are matched, causing the surveying instrument to measure the center of the target.
